(19) United States
(12) Patent Application Publication
(10) Pub. No.: US 2010/0329534 A1
(43) Pub. Date: Dec. 30, 2010

(54) METHOD AND DEVICE FOR THE ACQUISITION OF X-RAY IMAGES FOR A THREE-DIMENSIONAL IMAGE RECONSTRUCTION

(76) Inventors: Volker Biermann, Forchheim (DE); Jan Boese, Eckental (DE); Georg Buchheim, Forchheim (DE); Frank Dennerlein, Forchheim (DE); Michael Fuhrmann, Herzogenaurach (DE); Holger Kunze, Bubenreuth (DE); Alois Nöttling, Pottenstein (DE); Thomas Redel, Poxdorf (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/825,721

(22) Filed: Jun. 29, 2010

(30) Foreign Application Priority Data
Jun. 30, 2009 (DE) 10 2009 031 165.3

(51) Int. Cl. G06T 7/00; H05G 1/02

(52) U.S. Cl. 382/132; 378/197

(57) ABSTRACT

A method and an X-ray image acquisition system for the acquisition of X-ray images of a region of interest of an examination object from a multiplicity of angles of view for an 3-D image reconstruction are provided. The X-ray image acquisition system comprises an X-ray focus and an X-ray detector, which can be separately positioned and oriented relative to each other. The X-ray focus is moved along a combination of straight line segments and/or arc segments for the acquisition of X-ray images. The X-ray detector is oriented relative to the X-ray focus and moved in such a way that the region of interest is projected completely onto the X-ray detector upon each image acquisition.

### CROSS REFERENCE TO RELATED APPLICATIONS

This application claims priority of German application No. 10 2009 031 165.3 filed Jun. 30, 2009, which is incorporated by reference herein in its entirety.

### FIELD OF THE INVENTION

The invention relates to a method and a device for the acquisition of X-ray images of the region of interest (ROI) of an examination object from multiple angles of view by a radiography system. The invention is employed in medical engineering, in particular in 3-D X-ray radiography.

### BACKGROUND OF THE INVENTION

X-ray radiography systems are standard nowadays in medical imaging and are employed for a multiplicity of predominantly diagnostic tasks, for example for the diagnosis of bone fractures and lung nodules or the detection of anatomical abnormalities. It is the function of such X-ray radiography systems to provide image material of the region of the body to be examined (ROI: Region of Interest), in order to enable or facilitate a medical diagnosis. The X-ray images are obtained with the aid of an X-ray source and an X-ray-sensitive detector (X-ray detector). In the case of the C-arm systems preferably used in radiography, the X-ray detector and the X-ray source (X-ray focus) are arranged opposite each other on a so-called C-arm, which is designed to execute a rotational movement around the examination object. The image acquisition system, with the X-ray source and the X-ray detector, can thus rotate about a center of rotation, the so-called isocenter of the C-arm system. In this way with these modem C-arm systems it is possible not only to obtain two-dimensional fluoroscopic images, but also, by rotation of the image acquisition system around the patient, also three-dimensional, CT-like image data.

Depending on the range of angles of view for which corresponding X-ray images were created, on the one hand the image reconstruction method known from computer tomography or the so-called tomosynthesis method are suitable for the reconstruction of 3-D image data.

As well as the C-arm systems, radiography systems for mounting on a ceiling of an examination room are known, for example from the publication US 2003/0068008 A1, which have an X-ray focus and an X-ray detector, which can be separately positioned and oriented relative to each other.

The practical value of an X-ray image acquisition system, such as a radiography system, is highly dependent upon how well the X-ray image material which can be generated thereby can be used for effective and efficient diagnosis. Until now radiography systems have typically be employed solely for 2-D projection radiography. In this 2-D application, radiography images of the patient are acquired from one or a number of selected angles of image/view. The diagnosis then takes place directly on the basis of the 2-D X-ray images thereby generated.

A disadvantage of 2-D projection radiography is that the radiography images also display overlaid anatomical structures, and a diagnosis is frequently hampered by this overlaying. This is for example the case during the examination of lung nodules, which may be concealed by ribs, which renders the detection of the lung nodules significantly more difficult or even impossible. Furthermore, the diagnosis of complex bone fractures in 2-D projection images is difficult. A further disadvantage emerges from the clinical workflow.

Typically, the clinical diagnosis in complex cases takes the following course. After a 2-D radiography examination with suspicious results the patient is examined again with a diagnostic computer tomograph, which delivers high-quality 3-D image data, with the aid of which it is then generally possible to establish further diagnosis. The disadvantage of this is that the patient must first be conveyed to the CT-scanner and that the CT-scanner is generally subject to heavy usage so that immediate examination is not guaranteed. For efficient and effective diagnosis, 3-D imaging in the radiography is thus desirable.

In this connection radiography systems are known that permit 3-D imaging, which are based on so-called tomosynthesis technology. Such tomosynthesis technology or a corresponding radiography system is for example disclosed in the article: “Digital tomosynthesis of the chest for lung nodule detection: Interim sensitivity results from an ongoing NIH-sponsored trial”, James T. Dobbins III., H. Page McAdams, Jae-Woo Song, Christina M. Li, J. Godfrey, David M. DeLong, Sang-Hyun Paik, and Santiago Martinez-Jimenez, Med. Phys., June 2008, Vol. 35/6, pp. 2554-2557″. The tomosynthesis technology described therein provides 3-D image data, and thus offers advantages compared with a 2-D projection radiography. It does however not provide actual 3-D imaging, as known from computer tomography, because the image pixels generated have a very poor spatial resolution along the beam direction of the X-ray beams. The diagnosis of anatomical structures running perpendicular to this beam direction thus remains difficult.

DE 10 2006 040 943 A1 describes a typical diagnostic C-arm system, in which the breathing phase of a patient is recorded before, or as the case may be during scanning of the patient, wherein in each case an acquisition run is started upon a prescribed breathing phase being reached.

U.S. Pat. No. 6,155,713 also discloses a radiography system, which however comprises a first and a second X-ray source and an X-ray detector, which can in each case be positioned independently of each other.

### SUMMARY OF THE INVENTION

It is the object of the invention to specify a method and a device for the acquisition of X-ray images, which improves the aforementioned method in particular with respect to the precision and quality respectively of the X-ray images acquired, in particular in the case of radiography applications.

The invention is revealed by the features of the independent claims. Advantageous developments and embodiments are the subject matter of the dependent claims. Further features, application options and advantages of the invention are evident from the following description of exemplary embodiments of the invention, which are shown in the figures. Here, all the features described or represented, per se or in any desired combination, form the subject matter of the invention, independently of their summarization in the claims or their relatedness, and independently of their formulation or representation in the description or the figures respectively.

A first aspect of the invention relates to a method for the acquisition of X-ray images of a region of interest (ROI) of an examination object from a multiplicity of angles of view by means of a radiography system, wherein the radiography system comprises an X-ray focus and an X-ray detector, which can be separately positioned and oriented three-dimensionally, relative to each other.

According to the invention, the method is characterized in that the positioning and orientation of the X-ray focus and the X-ray detector are controlled in such a way that the X-ray focus for acquisition of X-ray images is moved along a 3-D trajectory, in particular a combination of straight line segments and/or arc segments, predefined such that a 3-D image can be reconstructed from the X-ray images acquired here, that the X-ray detector is oriented relative to the X-ray focus and moved in such a way that the region of interest for each image acquired is completely projected onto the X-ray detector, and that a 3-D image reconstruction takes place on the basis of the X-ray images acquired.

By means of the combination of different line segments and/or arc segments nearly any paths of the X-ray focus can be realized within the three-dimensional space around the examination object. The trajectory of the X-ray focus, which is given by the multiplicity of acquisition positions, or angles of view relative to the examination object, can thus consist of a combination of straight line segments, or straight line segments and arc segments, or different arc segments. Here, an arc segment is in the present case determined by a radius of curvature. The present invention explicitly excludes the case that arc segments with the same radius of curvature are combined in succession, so that a circular path is created by means of the combination of the arc segments, that is to say that the X-ray focus moves along a circumference.

In an advantageous development of the invention the line segments and/or arc segments are connected to each other. The totality of the line or arc segments respectively thus produces an X-ray focus path or X-ray focus trajectory, from which images of the region of interest (ROI) of the examination object from different angles of view are obtained. The movement of X-ray focus and X-ray detector around the region of interest (ROI) takes place on a continuous basis.

In a further preferred embodiment of the method the line segments and/or arc segments which define the trajectory of the X-ray focus and from which X-ray images are created are at least partially not connected to each other. This means that an end point, for example of a line segment, and a start point, for example of a neighboring arc segment, are not identical, but for further X-ray images a positioning of the X-ray focus from the end point of the line segment to the start point of the neighboring arc segment must take place. No X-ray images are created upon this transfer of the X-ray focus. In this case, corresponding jumps typically occur at the image acquisition angles.

The X-ray images are preferably obtained at equidistant points along the X-ray focus path (X-ray focus trajectory). Alternatively the images can be created at equidistant angles of view, for example in relation to a center of the region of interest (ROI).

In a further preferred embodiment of the method the X-ray focus is moved in one acquisition plane only during all acquisitions for the acquisition of X-ray images of the ROI. The X-ray focus can here for example be moved in an essentially rectangular path.

If the X-ray images created with the inventive method cover a sufficiently large range of angles of view, a 3-D image reconstruction can be performed with known methods and concepts from computer tomography. If the images acquired cover an insufficiently large range of angles of view, that is at least smaller than 180 degrees, a 3-D image reconstruction can then be performed with known methods and concepts from tomosynthesis.

A second aspect of the invention relates to a radiography system for the acquisition of X-ray images of a region of interest (ROI) of an examination object from a multiplicity of angles of view, which comprises an X-ray focus and an X-ray detector, which can be separately positioned and oriented three-dimensionally, relative to each other.

The inventive X-ray image acquisition system is characterized in that a control means is present, with which the positioning and orientation of the X-ray focus and of the X-ray detector is controllable in such a way that for the acquisition of X-ray images, the X-ray focus can be moved along a prescribed 3-D trajectory, in particular a combination of straight line segments and/or arc segments around the region of interest (ROI), such that a 3-D image can be reconstructed from X-ray images acquired thereby, that the X-ray detector can be oriented relative to the X-ray focus and moved in such a way that the region of interest in each image acquired is completely projected onto the X-ray detector, and that a means for image reconstruction is present, with which a 3-D image reconstruction can be performed from the X-ray images acquired.

### BRIEF DESCRIPTION OF THE DRAWINGS

Exemplary embodiments of the invention are described in more detail below, with reference to the figures, wherein:

FIG. 1 shows an X-ray image acquisition system according to the preamble of the independent claims as disclosed for example in the document US 2003/0068008 A1 (prior art),

FIG. 2 shows an X-ray detector which can be positioned and oriented three-dimensionally (prior art),

FIG. 3 shows an X-ray source with an X-ray focus which can be positioned and oriented three-dimensionally (prior art),

FIG. 4 shows a schematic block circuit diagram of an inventive X-ray image acquisition system,

FIG. 5 shows a first example of an inventive trajectory of an X-ray focus and a trajectory of an X-ray detector, and

FIG. 6 shows a second example of an inventive trajectory of an X-ray focus and a trajectory of an X-ray detector.

### DETAILED DESCRIPTION OF THE INVENTION

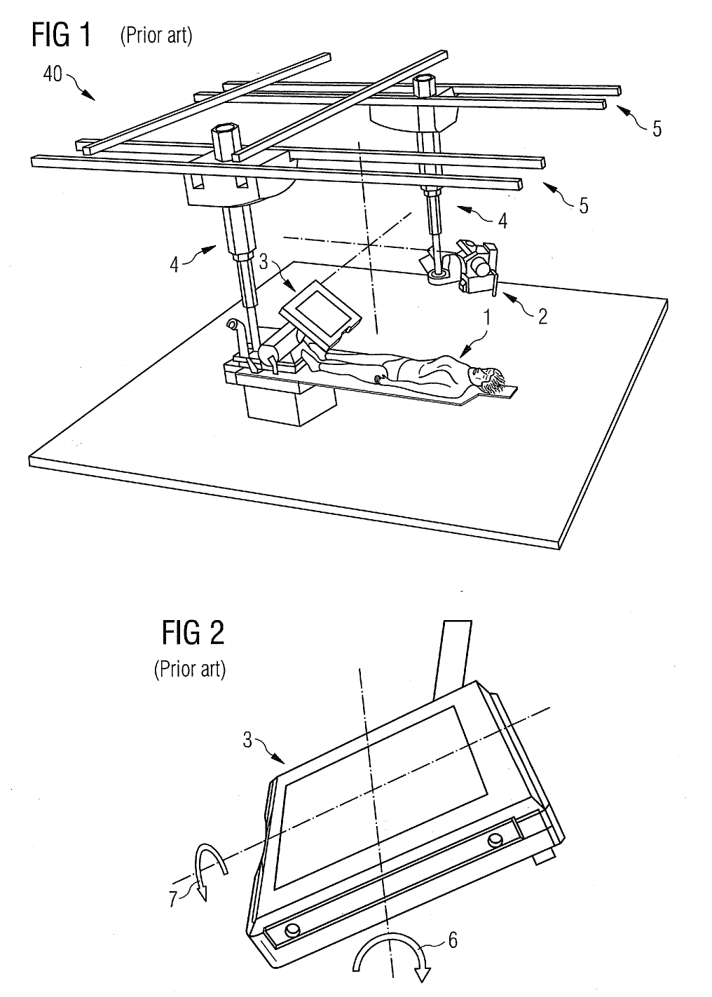

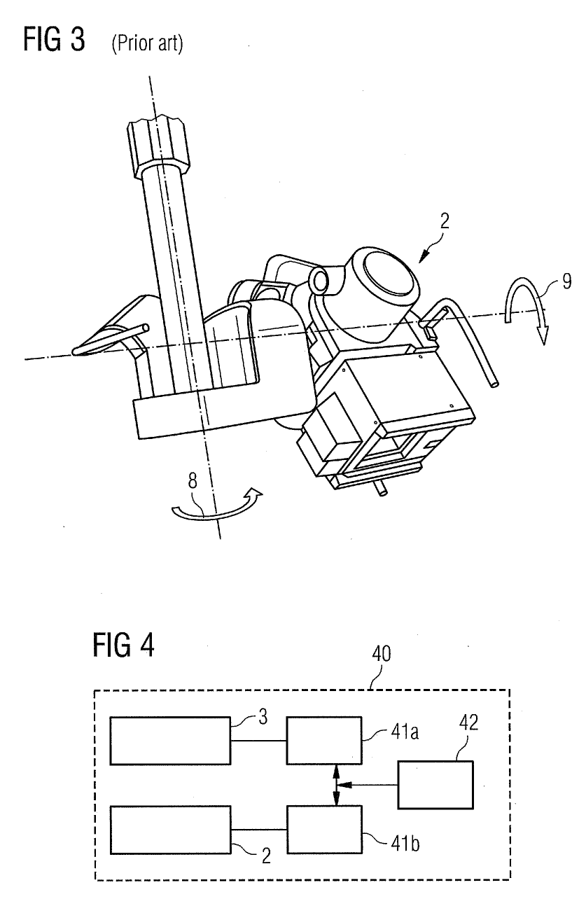

FIG. 1 (prior art) shows an X-ray image acquisition system 40 according to the preamble of the independent claims. Represented here are an X-ray source with an X-ray focus 2 and an X-ray detector 3, which are in each case attached to telescopic arms 4. The telescopic arms 4 are in turn fixed to a rail system 5, which enables almost any desired horizontal positioning of X-ray focus or X-ray detector respectively around the patient 1. The telescopic aims 4 can be moved independently of each other. The relative positioning of these two units with reference to the patient takes place by means of drive units (not shown). The orientation of X-ray focus 2 and X-ray detector 3 can be changed relative to each other by means of rotation around axes with the aid of additional drive means, as shown in FIG. 2 and FIG. 3.

FIG. 2 and FIG. 3 (prior art) show the degree of freedom of movement of the X-ray focus 2 or X-ray detector 3 arranged on the telescopic arms 4. This degree of freedom is enabled by rotational movements 6 and tipping movements 7 of the X-ray detector 3 or as the case may be rotational movements 8, 9 of the X-ray focus 2 about two axes.

According to the invention the X-ray image acquisition system 40 is now controlled in such a way that the X-ray focus 2 moves on a focus path around the patient 1, wherein the focus path consists of a combination of line segments and/or arc segments. An arc segment is here in particular defined by a uniform radius of curvature. In contrast to the known C-arm systems, in which the X-ray focus moves along a single arc, that is a circular arc, the focus path in the present case comprises straight line segments and/or arc segments, which have different arc radii.

The line segments and/or arc segments can here be connected to each other, although this need not be the case. During the acquisition of X-ray images the X-ray detector 3 is always controlled in such a way the region of interest ROI in each image acquired is completely projected onto the X-ray detector 3.

For synchronous control of the X-ray focus 2 or of the X-ray detector 3 respectively, a control means 42 is present with which the positioning and orientation of the X-ray focus 2 and of the X-ray detector 3 are controllable in such a way that X-ray focus 2 can be moved for acquisition of X-ray images along a combination of straight line segments and/or arc segments, and the X-ray detector 3 can be oriented relative to the X-ray focus 2 and can be moved in such a way that the region of interest in the case of each image acquired is completely projected onto the X-ray detector.

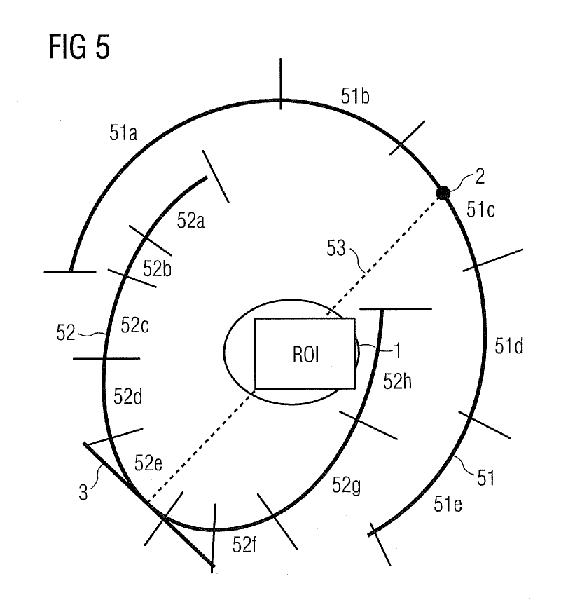

FIG. 4 shows a block circuit diagram of an inventive X-ray image acquisition system 40. The X-ray image acquisition system comprises an X-ray source with an X-ray focus 2 and an X-ray detector 3. For positioning and orientation of the X-ray detector 3 or of the X-ray focus 2 respectively a number of actuators 41a or 41b are present. According to the invention a control means 42 is further present, with which the positioning and orientation of the X-ray focus 2 and of the X-ray detector 3 are controllable in such away that for acquisition of X-ray images the X-ray focus 2 can be moved along a combination of straight line segments and/or arc segments, and the X-ray detector 3 can be oriented on the X-ray focus 2 and can be moved in such a way that the region of interest in the case of each acquisition is completely projected onto the X-ray detector.

FIG. 5 shows a first example of an inventive trajectory 51 of the X-ray focus 2 and trajectory 52 synchronously traveled by the X-ray detector 3. The diagram shows the region of interest ROI of the examination object 1 in cross-sectional form. The X-ray focus 2 and the X-ray detector 3 move along the trajectories 51 or 52 respectively, which likewise lie in the cross-sectional plane. For the acquisition of X-ray images a cone of beams with a central beam 53 is in each case transmitted at positions along the X-ray focus-trajectory 51 of the X-ray focus 2 through the region of interest ROI, which is displayed by the oppositely positioned X-ray detector 3. The X-ray detector 3 is here oriented relative to the X-ray focus such that the central beam 53 in each case meets the X-ray detector 3 in a vertical manner. The X-ray detector 3 is in the present case embodied in a flat, even manner.

The trajectory 51 represents the positions of the X-ray focus 2 which this traverses in order to acquire the images. The trajectory 52 represents the positions which the X-ray detector 3, that is to say the point of the X-ray detector 3 at which the central beam 53 is directed, traverses to generate the images. According to the invention the trajectory 21 of the X-ray focus 2 in this example comprises a combination of several arc segments 51a-51e arranged in a row, which are in each case defined by a correspondingly uniform radius of curvature. In the same way, the trajectory 52 of the X-ray detector 3 has corresponding arc segments 52a to 52h.

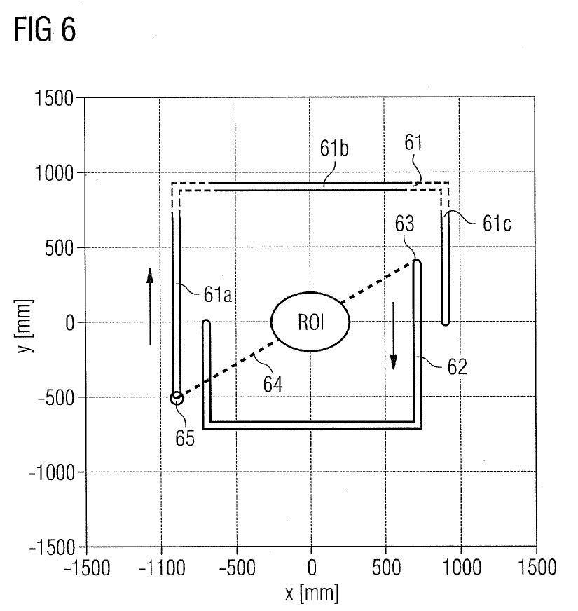

FIG. 6 shows a second example of an inventive trajectory 61 of the X-ray focus 2 and a trajectory 62 synchronously traversed by the X-ray detector 3. The movement of X-ray focus 2 and X-ray detector 3 here likewise takes place in one plane. The point of origin (isocenter) of this plane lies in the center of the region of interest ROI. The coordinate system gives the distances from the point of origin in the direction of an x- and a y-axis in mm. The z-axis perpendicular thereto is not shown.

A first acquisition of an X-ray image of the ROI takes place for an angle of view in which the X-ray focus 2 is located in position 65 and the X-ray detector 3 in position 63. X-ray focus 2 and X-ray detector 3 are here oriented relative to each other such that the ROI is completely projected onto the X-ray detector (3).

For the acquisition of further X-ray images the X-ray focus 2 moves in the assigned direction of the arrow along the trajectory 61 and the X-ray detector 3 in the assigned direction of the arrow along the trajectory 62. The acquisition of the X-ray image thus takes place in the present case with a planar trajectory 61 of the X-ray focus 2, which can be described mathematically as a circular path with a variable radius around the ROI. This trajectory 61 can be described in three-dimensional form (x-, y-, z-coordinates) for the present point of origin with the function

f(λ)=(R(λ)·cos(λ),R(λ)·sin(λ),0) (1)

λ is a path parameter, for example an angle, which describes the angular position of the X-ray source 2 during the circulation around the point of origin, and R(λ) is the variable path radius. The plane z=0 is the X-ray focus path plane.

The variable radius R(λ) is here set in such a way that the trajectory of the X-ray focus 2 essentially describes a rectangular path. The expression “essentially” here means for example that the corners of the rectangular path can be rounded. The X-ray detector 3 is further moved in such a way that the central beam 64 emitted from the X-ray focus 2 meets the center of the detector surface in a perpendicular manner. Furthermore, the distance between X-ray focus 2 and X-ray detector 3 during the acquisition of X-ray images is changed in such a way that the center point of the detector moves on the essentially rectangular path trajectory 62.

Acquisitions of X-ray images are here preferably made equidistantly spaced along the trajectory 61 of the X-ray focus 2.

A 3-D image data record is then reconstructed from the X-ray images acquired with the aid of a reconstruction method, for example with an iterative or an analytical method. For the reconstruction it is necessary to know the acquisition geometry of the X-ray image acquisition system 40, that is in particular the precise position and orientation of the X-ray focus 2 and the X-ray detector 3 for each individual X-ray image of the entire sequence. This geometric information is preferably determined in a calibration step before or during performance of the inventive method. A specially shaped calibration object can for example be used for this purpose, which is located in every acquisition position in the beam path. Inaccuracies in the geometric information thus determined, which frequently have a negative effect on the achievable image quality, can be minimized in algorithmic correction steps after the data acquisition, for example in that during the image acquisition special markers are applied to the patient, with the aid of which a retrospective adjustment of the geometric information is possible, or also by means of a retrospective adjustment without special markers.

In FIG. 6 the X-ray images cover a range of angles of view of 180° plus a fan angle (not shown), so that for reconstruction of 3-D image data an image reconstruction method is used as employed in CT-imaging.

The inventive method and the inventive X-ray image acquisition system enable 3-D imaging in radiography for supporting medical diagnosis, especially in cases in which a comprehensive diagnosis based on conventional 2-D projection data is not possible. The inventive method can be performed on a conventional 2-D projection radiography system. The conveying of a patient to a CT system after a 2-D radiography examination as previously required is unnecessary. Furthermore, based on the invention, a 3-D imaging in different examination positions of a patient is possible, for example when the patient is standing, sitting or lying down, whereas for example the examination of standing patients is not possible in diagnostic computer tomography systems.

The inventive method and the inventive X-ray image acquisition system 40 are based on data acquisition that differs from the customary acquisition with C-arm systems or CT systems. In particular, the invention makes it possible to set any desired distance, within a very large range, between X-ray focus 2 and X-ray detector 3 during the acquisition. The distances between X-ray focus 2 and isocenter, or X-ray detector 3 and isocenter are likewise independent of each other and can be set at will. Examination objects 1 with cross sections of large size or of a special nature can thus advantageously be examined.

In comparison to other radiographic imaging systems, which are based on the tomosynthesis principles, the invention delivers improved—right up to isotrope—3-D spatial resolution. This resolution is in addition potentially higher with diagnostic computer tomography systems (CT scanners), as the detector pixel size in the case of radiography systems is typically smaller than with CT scanners.

1.-8. (canceled)

9. A method for acquisition of X-ray images of a region of interest of an examination object from multiple angles of view by a radiography system comprising an X-ray focus and an X-ray detector that can be separately positioned and oriented relative to each other three-dimensionally, comprising:
moving the X-ray focus along a prescribed 3-D trajectory during the acquisition;
orienting and moving the X-ray detector relative to the X-ray focus so that the region of interest are completely projected onto the X-ray detector during the acquisition; and
reconstructing a 3-D image based on the acquired X-ray images.

10. The method as claimed in claim 9, wherein the prescribed 3-D trajectory is a combination of straight line segments and/or arc segments.

11. The method as claimed in claim 10, wherein the straight line segments and/or the arc segments are connected to each other.

12. The method as claimed in claim 10, wherein the straight line segments and/or arc segments are at least partially not connected to each other.

13. The method as claimed in claim 9, wherein the X-ray focus is moved in an acquisition plane during the acquisition.

14. The method as claimed in claim 13, wherein the X-ray detector is moved in the acquisition plane during the acquisition.

15. The method as claimed in claim 9, wherein the X-ray focus is moved on an essentially rectangular path for the acquisition of the X-ray images.

16. The method as claimed in claim 9, wherein the 3-D image is reconstructed by a tomosynthesis technology.

17. A radiography system for acquisition of X-ray images of a region of interest of an examination object from multiple angles of view, comprising:
an X-ray focus;
an X-ray detector that can be separately positioned and oriented three-dimensionally relative to the X-ray focus;
a control device that controls:
a movement of the X-ray focus along a prescribed 3-D trajectory around the region of interest during the acquisition, and
an orientation and movement of the X-ray detector relative to the X-ray focus so that the region of interest are completely projected onto the X-ray detector during the acquisition; and
an image reconstruction device that reconstructs a 3-D image from the acquired X-ray images.

18. The radiography system as claimed in claim 17, wherein the prescribed 3-D trajectory is a combination of straight line segments and/or arc segments.
